(19) United States
(12) Patent Application Publication
(10) Pub. No.: US 2013/0145736 A1
(43) Pub. Date: Jun. 13, 2013

(54) MOWER DECK

(71) Applicant: Oliver Deutschle, Roggenburg (DE)

(72) Inventor: Oliver Deutschle, Roggenburg (DE)

(73) Assignee: WIEDENMANN GMBH, Ulm (DE)

(21) Appl. No.: 13/491,907

(22) Filed: Jun. 8, 2012

(30) Foreign Application Priority Data
Jun. 10, 2011 (DE) 10 2011 103 957.4
Aug. 3, 2011 (DE) 10 2011 080 385.8

(51) Int. Cl. A01D 34/66

(52) U.S. Cl. CPC A01D 34/66
USPC 56/6

(57) ABSTRACT

A mower deck having a first mower unit and a second mower unit. The second mower unit is fastened on the first mower unit a double joint arrangement so the second mower unit can swing upwards.

### CROSS-REFERENCE TO RELATED APPLICATIONS

This application claims priority under 35 U.S.C. §119(a) to German Patent Application No. 10 2011 103 957.4, filed in Germany on Jun. 10, 2011, and to German Patent Application No. 10 2011 080 385.8, filed in Germany on Aug. 3, 2011 the entire contents of German Patent Application Nos. 10 2011 103 957.4 and 10 2011 080 385.8 are hereby incorporated herein by reference.

### BACKGROUND

1. Field of the Invention

The present invention relates to a mower deck.

2. Background Information

In practice, mower decks are built onto vehicles, such as, for example, tractors such that the tractors provided with a mower deck can be used as self-propelling lawn mowers. There are variously sized mower decks for variously powered tractors or other vehicles. Mower decks, as a rule, are provided with one or more rotating cutting blades, as is well known in the case of lawn mowers. The cutting blades rotate in a blade plane in order to shorten the blades of grass in a corresponding manner.

An example of a known mower deck is described in DE 10 2005 050 215 A1. In principle, the term mower decks refers to mowing devices which are suitable for mowing larger areas and have a plurality of cutting blades arranged side by side for this purpose. In this case, the operating efficiency of the mower decks is determined, as a rule, by the width of the mower deck. Using wide mower decks, it is possible to mow a wider area in one operation which means that a mowing time needed for a given area overall is shorter than in the case of narrower mower decks.

### SUMMARY

However, a problem with wide mower decks is that they are very restrictive when being transported. Often the width of approaches to lawn areas are restricted such that vehicles provided with very wide mower decks may not be able to pass through such approaches.

Another difficulty in the case of very wide mower decks is that they cannot easily be adapted to ground conditions. A rigid wide mower deck can only provide one cutting plane, which is disadvantageous where there are more severe curvatures in the ground.

Consequently, it is the object of the invention to create a mower deck which provides a smaller transport width and a larger operating width and, in addition, is able to be adapted better to irregularities in the ground than in the case of mower decks with a variable width known up to now. Disclosed embodiments provide a mower deck having a first mower unit and a second mower unit. The second mower unit is fastened on the first mower unit by a double joint arrangement so the second mower unit can swing upwards.

By providing two mower units which can be swung down towards each other, a wide cutting plane and a smaller transport width can be created. Through the connection by a double joint arrangement, highly variable adaptation to the ground can be achieved as a result of the various pivot possibilities which are provided by such a double joint.

For example, the second mower unit can be pivoted about at least two pivot axes in relation to the first mower unit. Thus, in an advantageous manner, the mower deck can be pivoted, for example, downwards about a lower pivot axis and, for example, upwards about an upper pivot axis such that the cutting plane of the second mower unit remains in an optimum manner on the ground. The mower units can be provided, for example, in each case with their own rolling devices in order to support the mower units with respect to the ground such that where there are ground irregularities swinging movements can be carried out by rolling off.

The term “double joint arrangement”, in this case, is not to be seen in a restricting manner such that it can only include joint arrangements with a maximum of two joints. Rather, the term is understood such that, for example, a triple joint arrangement with three pivot axes also refers to a double joint arrangement to which another pivot axis is added. Consequently, therefore, mower decks with mower units which are pivotable towards each other about more than two pivot axes are included by the invention.

In one example, the first mower unit has a first mower housing with a vehicle coupling device for fastening to a vehicle, and the second mower unit has a second mower housing which is coupled to the first mower housing by the double joint arrangement so the second mower housing can swing downwards. In this example, a drive device of the mower deck has a belt and chain drive for driving the second mower unit, said belt and chain drive extending from the first mower unit to the second mower unit.

Also, the double joint arrangement can have an upper hinge joint arrangement for pivoting the second mower unit in relation to the first mower unit about an upper pivot axis, preferably extending in a horizontal direction, and a lower hinge joint arrangement for pivoting the second mower unit in relation to the first mower unit about a lower pivot axis, preferably extending in a horizontal direction. The pivot axes extend in a substantially parallel manner, such that a first stop is provided for defining the pivoting movement about the upper pivot axis in a first pivoting direction and a second stop is provided for pivoting the pivoting movement about the lower pivot axis in a second pivoting direction which is in an opposite direction to the first pivoting direction.

The double joint arrangement can be pre-tightened by a pre-tightening device abutting against at least one of the stops, preferably abutting against the first stop. Also, the double joint arrangement can have several double joints which, when seen in the direction of the pivot axis, are arranged at a spacing with respect to each other and are provided in each case with an upper and a lower hinge joint such that the plurality of hinge joints forms the respective hinge joint arrangement, wherein the hinge joints of each double joint are connected in each case by a connecting rod.

In addition, the first mower unit can have at least one first cutting blade which is mounted so as to be rotatable about a first vertical axis and in that the second mower unit has at least one second cutting blade which is mounted so as to be rotatable about a second vertical axis. The cutting blades can rotate substantially in a common cutting plane, such that a lower pivot axis of the double joint arrangement is arranged in the cutting plane or in the vicinity of the cutting plane.

Also, mower housings can have in each case an upper housing wall for closing off the mower chambers at the top, such that an upper pivot axis of the double joint arrangement, which extends substantially parallel to the lower pivot axis, extends at the level of the upper housing wall or above the upper housing wall. The double joint arrangement in this example defines two pivot axes which are arranged offset with respect to each other both in the vertical direction of the mower deck and in a lateral direction which extends transversely with respect to the pivot axes, such that the pivot axes are further removed from each other in the vertical direction of the mower deck than in the lateral direction.

Furthermore, the first mower unit in this example is a middle mower deck element with a plurality of rotating first cutting blades, in that on two opposite sides of the middle mower deck element a second mower unit is attached in each case on the middle mower deck element so it can swing upwards. An actuating element for actuating a swinging movement between the mower units engages above the double joint arrangement. The actuating element has a first coupling which cooperates with the first mower unit and a second coupling which cooperates with the second mower unit and a displacement device for the preferably driven relative displacement of the couplings, such that the actuating element or the displacement device is preferably realized as a telescopic arm or telescopic cylinder.

The first mower unit has a first drive which is connectable to a secondary drive of a vehicle, to which the mower deck is to be connected, and in that the second mower unit has a second drive which is to be coupled to the first drive by a controllable coupling. The second mower unit is driven by a belt and chain drive which has a drive wheel arranged on the first mower unit and a driven wheel arranged on the second mower unit, such that at least one belt run of the traction device of the belt and chain drive is guided at the level of a pivot axis of the double joint.

In this example, at least one belt run crosses the upper pivot axis of the double joint in an inclined manner such that a direction component of the belt run and of the pivot axis coincide. Also, both a tight belt run and a slack belt run of the belt and chain drive are guided by guide rollers, which are arranged in each case offset with respect to each other in the direction of the pivot axis, at the level of the pivot axis, extending at an incline with respect to said pivot axis over the separation point between first and second mower unit.

### BRIEF DESCRIPTION OF THE DRAWINGS

Exemplary embodiments of the invention are explained below by way of the accompanying drawing, in which, in detail:

FIG. 1 shows a bottom view of an exemplary embodiment of a mower deck having several mower units which are fastened to each other by double joint arrangements so they can swing down towards each other;

FIG. 2 shows a schematic perspective view of the mower deck with indication of a vehicle to which the mower deck is coupled;

FIG. 3 shows a perspective top view when seen from the front, the side and above onto the mower deck, a cover over a drive device having been removed;

FIG. 4 shows a front view of the joint region between two mower units of the mower deck in a first position;

FIG. 5 shows a perspective representation of the joint region of FIG. 4 in the first position;

FIG. 6 shows a further perspective representation of the joint region in the first position;

FIG. 7 shows yet another perspective representation of the joint region in the first position;

FIG. 8 shows a front view of the joint region in a second position, in which a lateral second mower unit is swung downwards somewhat with respect to a middle first mower unit following an irregularity in the ground;

FIG. 9 shows a perspective representation of said second position of the joint region of FIG. 8;

FIG. 10 shows the joint region between the mower units in a third position, where the second mower unit is swung upwards somewhat in relation to the first mower unit following an irregularity in the ground;

FIG. 11 shows a perspective representation of the third position according to FIG. 10;

FIG. 12 shows a front view of the joint region between the mower units in a transport position, the second mower unit being swung completely up in relation to the first mower unit;

FIG. 13 shows a first perspective view of the joint region in the transport position; and

FIG. 14 shows a second perspective view of the joint region in the transport position.

### DETAILED DESCRIPTION OF EMBODIMENTS

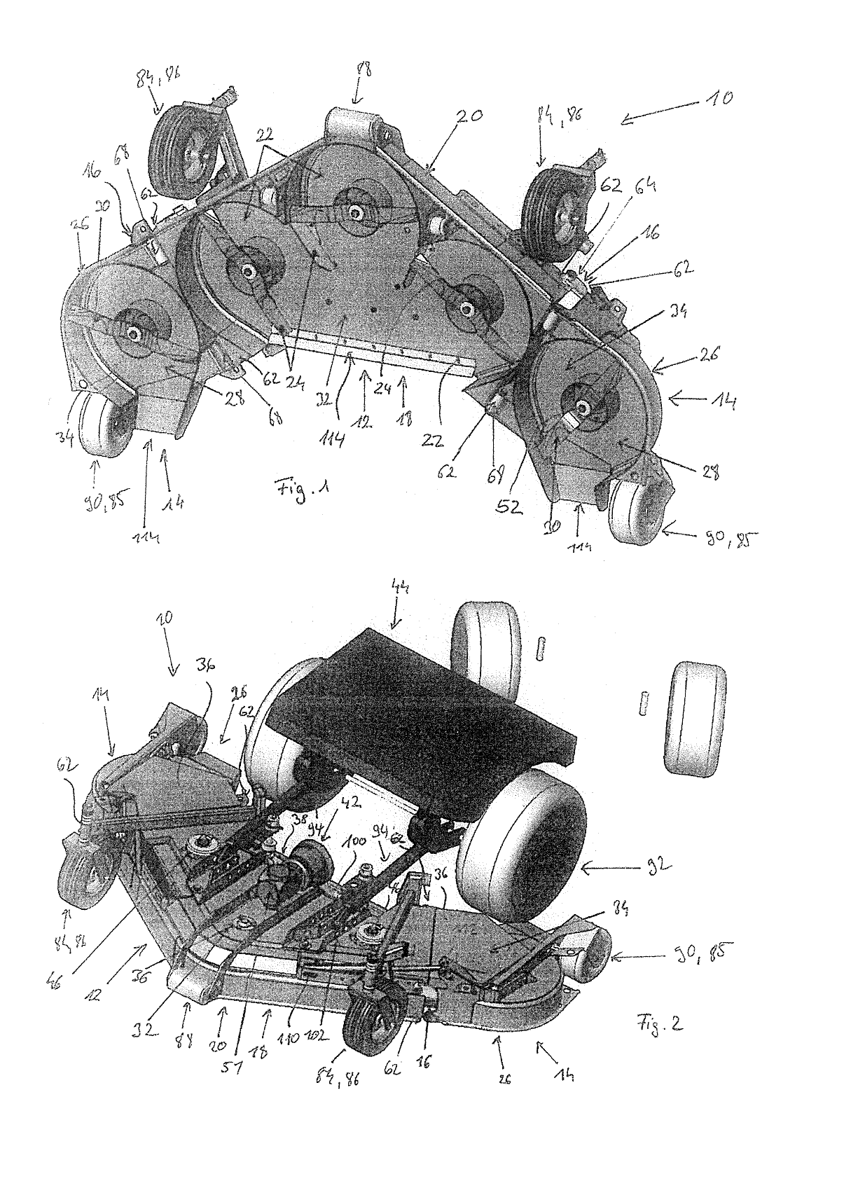

The mower deck 10 represented as a whole in FIGS. 1 and 2 has a first mower unit 12 and at least one second mower unit 14, with the second mower unit 14 being fastened to the first mower unit by a double joint arrangement 16 so the second mower unit 14 can swing upwards. In the embodiment shown, the first mower unit is a middle or central mower deck element 18, on the two side regions of which two second mower units 14 are coupled so as to be able to swing upwards. Each second mower unit 14 is coupled to the mower deck element 18 by a double joint arrangement 16 each so they are able to swing. The mower deck 10 is realized in a substantially mirror-symmetrical manner with respect to its corresponding vertical central longitudinal plane in the direction of travel such that the two second mower units 14 correspond to each other in a mirror-inverted manner and only one of the two second mower units is described in detail.

The mower deck element 18 has a first mower housing 20, which accommodates a plurality of first cutting chambers or first mower chambers 22, in which in each case one of several first cutting blades rotates. The second mower units 14 have in each case a second mower housing 26 which, in the embodiment shown, in each case define a second mower chamber 28, inside which in each case a second cutting blade 30 rotates. In further possible developments, which are not shown in any more detail, at least one of the second mower housings 26 also includes a plurality of second mower chambers 28, in each case a second cutting blade rotating in each second mower chamber 28.

The mower housings 20, 26 have in each case an upper housing wall 32, 34, which define the respective mower chambers 22, 28 at the top. Drives 38, 40 for the mower units 12, 14 are located above said upper housing walls 32, 34 underneath drive covers 36. A first drive 38 of the first mower unit 12, in this case, is connectable by means of a power take-off connection 42 to a secondary drive (not shown) of a vehicle 44 indicated in FIG. 2. Each second mower unit 14 has a second drive 40, which in each case is connectable to the first drive 38 by means of a coupling 46 so as to be engageable. The drives 38, 40 are realized in each case as V-belt drives 48. Accordingly, a drive device 50 of the mower deck 10, which includes the first drive 38 and the second drive 40, has in each case a belt and chain drive 51 for driving each second mower unit 14, the belt and chain drive 51 being connected to the first drive 38 of the first mower unit 12 and to a drive shaft 52 of the second cutting blade 30.

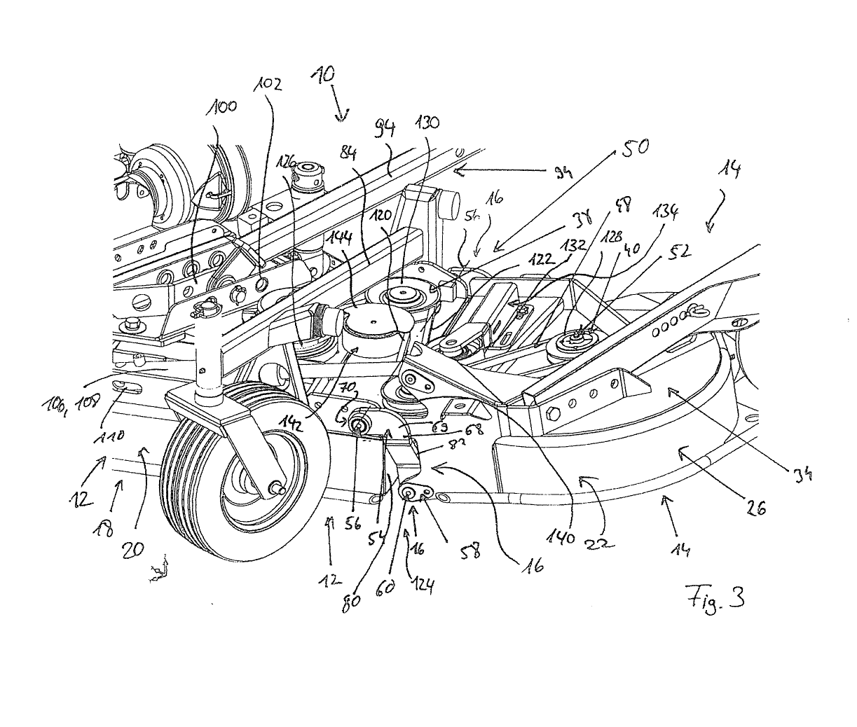

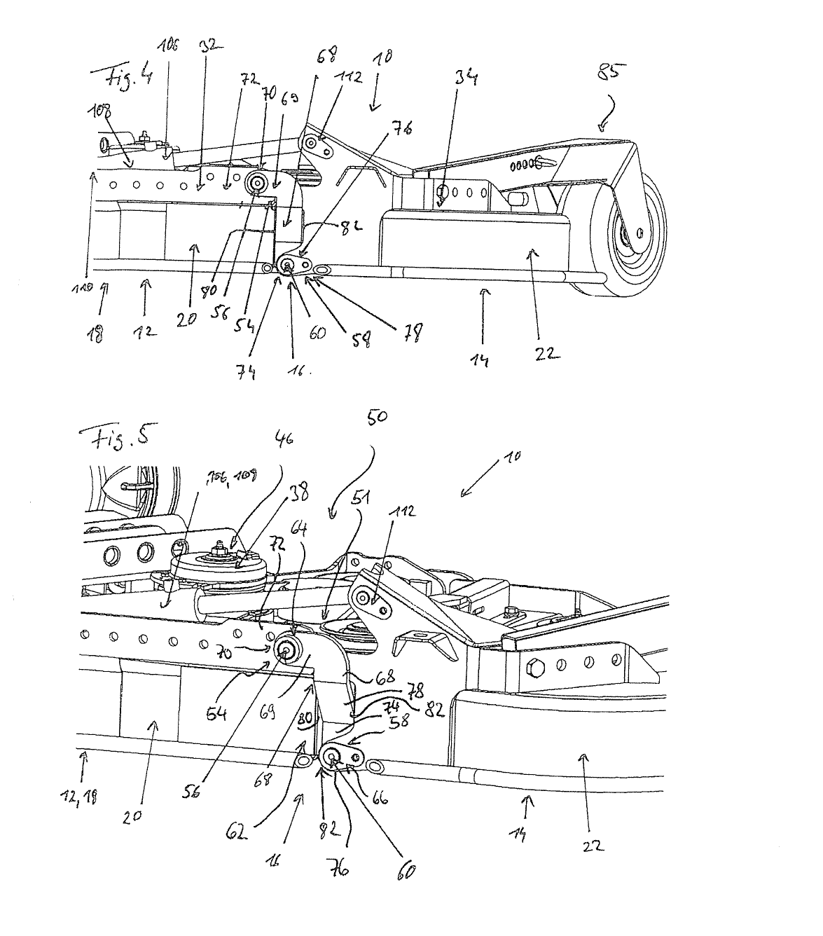

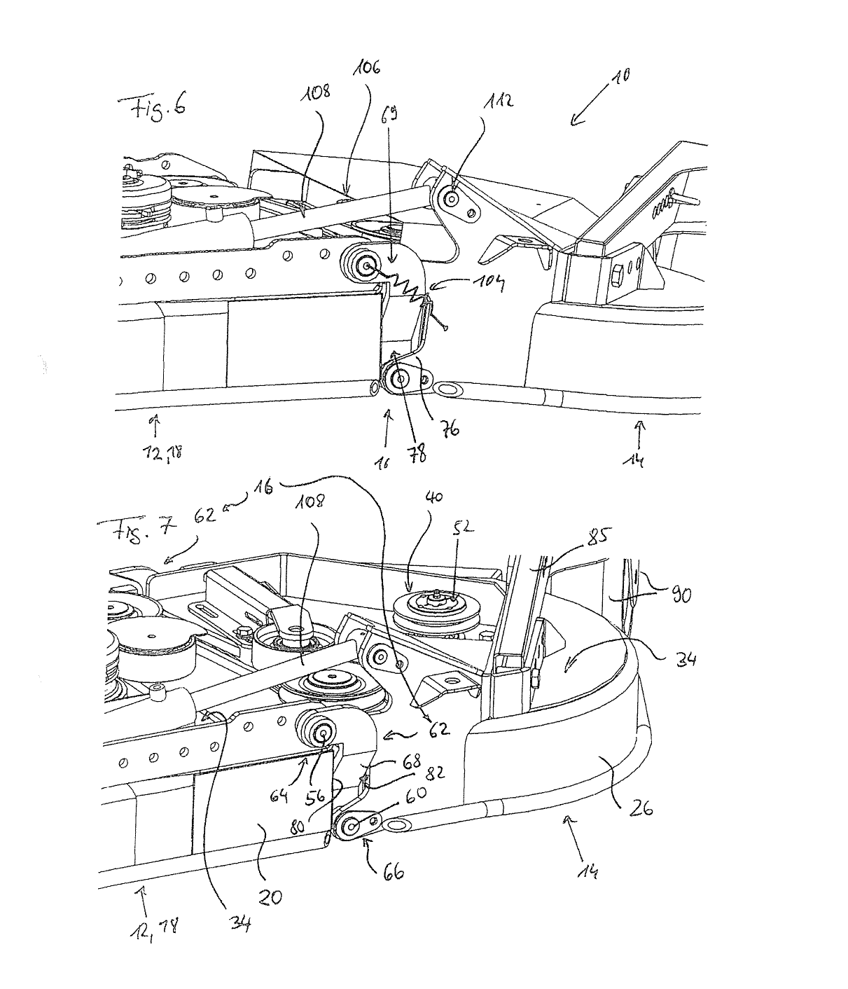

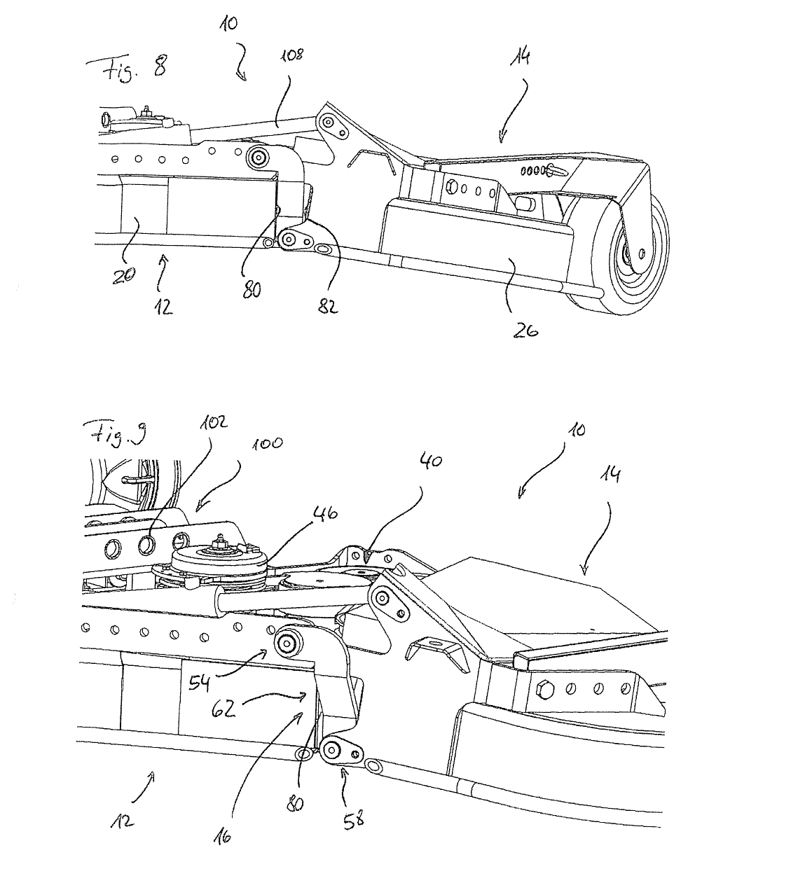

As can be seen from FIG. 3, the double joint arrangement 16 has an upper hinge joint arrangement 54 for pivoting the second mower unit 14 in relation to the first mower unit 12 about an upper pivot axis 56 and a lower hinge joint arrangement 58 for pivoting the second mower unit 14 in relation to the first mower unit 12 about a lower pivot axis 60. The two pivot axes 56, 60 extend in a substantially parallel manner. In the exemplary embodiment shown, the pivot axes 56, 60 extend in a direction which is to be arranged in a horizontal manner and is inclined obliquely with respect to the direction of travel. Attaching the second mower unit 14 on the first mower unit 12 in an inclined manner achieves an overlap between the cutting widths of the second cutting blade 30 and lateral first cutting blades 24 in spite of a compact arrangement.

The second mower unit 14 is consequently driven by means of the belt and chain drive 51. The belt and chain drive is realized, for example, as a V-belt drive 48. In the exemplary embodiment shown, both a tight belt run 120 and a slack belt run 122 of the belt and chain drive 51 are guided over the separation point between the first mower unit 10 and the second mower unit 14. Accordingly, the belt and chain drive 51 is driven by a drive wheel 126 which is arranged on the first mower unit 12 and drives a driven wheel 128 which sits on the second mower unit 14 in order, in this way, to drive the cutting blade of the second mower unit 14. To this end, the chain and belt drive 51 is guided at the level of the upper pivot axis 56. For this purpose, one of the belt runs 120, 122 is guided over a first guide roller 130 on the first mower unit 12 in an inclined manner with respect to the upper pivot axis 56 extending to a second guide roller 132 in order then to run to the driven wheel 128. The first guide roller 130 and the second guide roller 132 are arranged offset with respect to each other in the direction of the upper pivot axis 56 such that the belt run 130 guided thereby runs in an inclined manner with respect to the pivot axis 56, crossing said pivot axis. In other words, a direction component of the belt run 120 coincides with the pivot axis 56. In this case, the course of the belt run is selected in such a manner that the belt run extends more to the pivot axis 56 than vertically inclined thereto. The second guide roller 132 is realized as a smooth roller and is arranged on a linear belt tightener 134 in order to tighten the corresponding belt run 120.

The other belt run 122, coming from the driven wheel 128, is guided on a third guide roller 140 on the second mower unit 14, in a correspondingly parallel manner with respect to the other belt run 120, to a fourth guide roller 142 on the first mower unit 12 in order then to run back to the drive wheel 126. In this case, the fourth guide roller 152, which is mounted on the first mower unit 12, is realized in a smooth manner and has a guide plate 144 for defining the guiding, whilst the third guide roller 140, which is mounted on the second mower unit 14, is realized as a V-belt roller for the precise lateral guiding of the belt run 122. The third guide roller 140 and the fourth guide roller 142 are also offset with respect to each other in the direction of the pivot axis 56 such that the other belt run 122 also runs at an incline with respect to the pivot axis 56, crossing said pivot axis.

On account of the guiding of the belt runs 120, 122 at the level of the upper pivot axis, the two pieces of the traction device can be held approximately on the plane of the pivot axis and are not stressed any more even when the second mower unit 14 is swung upwards in relation to the first mower unit 12, but rather are only twisted together. A smaller amount of stress can be achieved by the belt runs 120, 122 being held in a more inclined manner towards the pivot axis such that the traction device only experiences a small amount of stress towards the side. Thus, it is possible to realize a belt and chain drive 51 which hardly experiences stresses even when the second mower unit 14 is frequently pivoted upwards and consequently it is able to be realized with a very long service life.

As can be seen from FIGS. 4 to 7, in a first position, which represents the mower deck 10 travelling over even ground, the cutting planes of the first cutting blades 24 coincide with the cutting planes of the second cutting blades 30. The lower pivot axis 60 extends inside said cutting plane which includes all the cutting blades 24, 30; i.e. more precisely approximately at the level of said cutting plane or offset only slightly up or down thereto.

The upper pivot axis 56 extends approximately at the level of the upper housing walls 32, 34 or slightly above said upper housing walls 32, 34. Consequently, the pivot axes 56, 60 are offset in the vertical direction with respect to each other. The pivot axes 56, 60 almost coincide in a vertical plane through the double joint arrangement 16; as can be seen in FIG. 4, the lower pivot axis 60 is arranged only slightly offset towards the side with respect to the upper pivot axis 56; the dimension of said lateral offset is considerably smaller than the dimension of the offset in the vertical direction.

As can be seen in FIG. 1, the double joint arrangement 16 has several double joints 62, which are arranged offset with respect to each other in the direction of the pivot axis and in each case have an upper hinge joint 64 and a lower hinge joint 66 and a connecting rod 68 therebetween. As can best be seen in FIG. 4, the connecting rod 68 is realized in an angular manner with a first portion 69 and a second portion 78 and is pivotably mounted by way of a first end 70 on a frame element or housing element 72 such that the bearing axis forms the upper pivot axis 56. The second end 74 of the connecting rod 68 is pivotably mounted between two joint projections 76, which joint projections 76 are realized in an integral manner with a housing wall of the second mower housing 28. The bearing axis of the bearing arrangement of said second end 74 forms the lower pivot axis 60. A stop of a second portion 78 of the connecting rod 68, bearing the second end 74, on the first mower housing 20 forms a first stop 80, which defines a pivoting movement of the double joint arrangement 16 about the upper pivot axis 56 in a first pivoting direction (clockwise when seen in FIG. 4).

The second mower housing 26 abutting against the second portion 78 of the connecting rod 68 forms a second stop 82 which defines a pivoting about the lower hinge axis 60 in a second pivoting direction, which is in an opposite direction to the first pivoting direction. The second pivoting direction would be counter clockwise when viewed in FIG. 4.

As can be seen from FIG. 1 and FIG. 2, the first mower unit 12 has a first framework 84 with front roller feelers 86 and a front feeler roller 88 by way of which the distance between the mower deck 10, and in particular the first mower unit 12, and the ground is maintained. The two second mower units 14, in each case, have a second framework 85 with plastic wheels, such as rear wheels 90, which are attached laterally to said outer units 14, by way of which the second mower units 14 are supported on the ground. In the case of the embodiment shown, the front roller feelers 86 are pivotable about vertical axes in order to follow steering movements of the vehicle (see FIG. 2). With regard to their direction, the rear wheels 90 of the second mower units are fastened rigidly to the mower units and through their rear arrangement are arranged closer to the vehicle wheels 92.

FIG. 2, in this case, indicates a front coupling to a vehicle 44, the rear wheels of which are realized so as to be steerable. For the front coupling to the vehicle 44, the first mower unit 12 has on its upper side a vehicle coupling device 100 with several fastening openings 102. For example, a front connecting rod 94 of the vehicle 44 can be fastened thereto. A middle fastening in the middle region of a vehicle which, for example, is front wheel driven (not shown) is also conceivable and possible.

FIGS. 4 to 7 show the situation when travelling over even ground. The mower units 12, 14 are aligned in a straight manner with respect to each other, the connecting rod 78 abutting against the two stops 80, 82. As indicated in FIG. 4, a pre-tightening device 104 can be provided in order to pre-tighten the double joint arrangement 16 in one of the stops 80, 82, in this case in particular abutting against the first stop 80. The pre-tightening device 104 is provided in particular to counteract a tightening of the traction device of the belt and chain drive 51 in order to avoid such a tightening of the traction device of the belt and chain drive 51 making the second mower unit 14 swing upwards in an unwanted manner and thereby lifting the mower unit 14 from the ground.

For each second mower unit 14, the mower deck 10 has an actuating element 106, by way of which, however, such swinging upwards can be managed in an intended manner for transport purposes. In particular, the actuating element 106 has, as a displacement device, a telescopic cylinder 108, which cooperates with the first mower unit 12 by way of a first coupling 110 and cooperates with the second mower unit 14 by way of a second coupling 112. In the mower operation shown in FIGS. 4 to 11, the telescopic cylinder 108 permits a clearance such that the second mower unit is pivotable by a defined range in relation to the first mower unit. Such a clearance can be achieved, for example, by an elongated slot connection on one of the two couplings 110, 112. For example, the possible pivoting range is between 7 and 10 degrees. The telescopic cylinder 108 is realized for the purpose of modifying the relative position of the couplings 110, 112 in order to swing the second mower unit 14 upwards or downwards as required.

FIG. 8 shows a situation in the mowing operation where a region of ground to the side of the first mower unit 12 drops away in relation to the region of ground travelled over by the first mower unit 12. The same situation is shown in perspective in FIG. 9. As can be seen from FIGS. 8 and 9, in this case the second mower unit is pivoted about the lower pivot axis 60 in relation to the first mower unit. This adapting to the ground is made possible by the clearance in the actuating element 106.

The connecting rod 68 remains abutting against the first stop 80. By pivoting about a pivot axis 60 inside the plane of the cutting blade, it is possible to achieve optimum adaptation to the ground with the cutting blades guided closely over the ground.

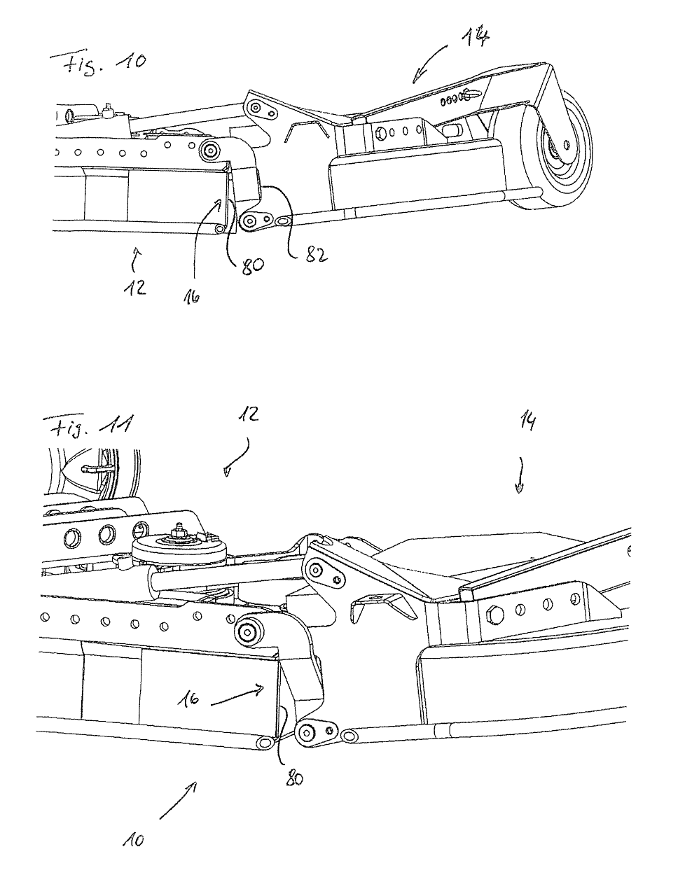

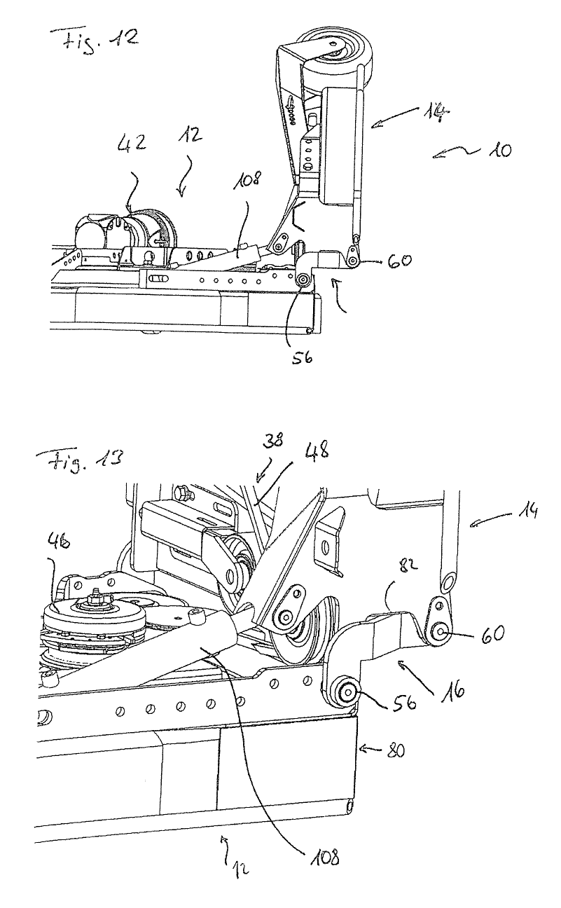

FIGS. 10 and 11 show a situation where a region of ground rises to the side of the first mower unit 12. Accordingly, the second mower unit 14 is swung upwards somewhat in a guided manner above the rear wheels 90 in relation to the first mower unit 12. In this case, the connecting rod 68 remains in its catch on the second stop 82 such that the pivoting is effected not around the lower pivot axis 60 but around the upper pivot axis 56. Thus, pivoting upwards is possible, it being possible nevertheless to arrange the mower units 12, 14 very close to each other in normal operation over even ground and consequently a neat overlap in the cutting width of the cutting blades is achievable in a simple manner.

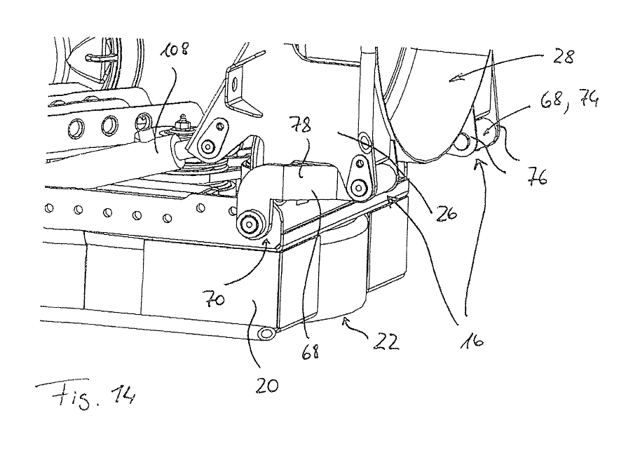

FIGS. 12 to 14 show the swung-up position; to this end, the telescopic cylinder 108 is retracted such that the second coupling 112 is moved towards the first coupling 110. As soon as the clearance, which is formed, for example, by an elongated slot in one of the couplings 110, 112, has been overcome, the corresponding coupling engages and pulls the second mower unit 14 upwards, the pivoting around the upper pivot axis 56 being effected. In the position swung up in this manner, it is possible to achieve a transport width which is considerably reduced in relation to the overall operating width of the mower deck 10.

The exemplary embodiment of the mower deck 10 shown in the Figures represented has a five blade mower mechanism, the first mower unit 12 being a middle rigid unit with three rotary blades and an operating width of, for example, between 1 and 1.8 m, preferably 1.4 m. The first mower unit 14 is preferably closed per se and realized without any lateral opening. In this respect, the mower deck 10 could also be operated with the lateral mower units 14 swung up if, for example, a grassed area has restrictions and a smaller operating width is consequently desired. The second mower units 14, which are realized in the development shown in each case as single blade units with one cutting blade 30, are attached to the side of said rigid first mower unit 12 on each of the two sides. The second mower units 14 are preferably also closed per se and can be swung in for example in a manual, hydraulic or electric manner in order, in this way, to create a transport width of the mower deck 10 of little more than the working width of the middle first mower unit 12. The transport width is preferably between 1.2 and 2 m and is preferably 1.8 m. For example, working widths of between 2 and 3 m, in particular 2.3 m, with transport widths of between 1 and 2 m, for example 1.8 m, can be achieved.

All the cutting blades 24, 30 are preferably realized in an identical manner, which simplifies the supply of spare parts. For example, diameters of rotary blades are provided within the range of 50 cm±20 cm (in particular 528 mm).

The first drive 38 for driving the first mower unit 12 is preferably a mechanical drive for driving the inside unit with V-belts, preferably with an aramid traction strand. The second drive 40, which is provided in each case with each of the second mower units 14, is also preferably a V-belt drive 48 with V-belt with an aramid traction strand.

The first mower unit 12 is engaged and disengaged, for example, by a mechanical power take-off shaft of the vehicle 44 and is consequently to be controlled by engaging and disengaging the secondary drive of the vehicle 44. Each of the second mower units 14 can be connected or disconnected independently of each other by the respective coupling 46. The couplings 46 are preferably realized in each case as an electromagnetic coupling with a brake for rapid immobilization of the blades. Using the brake, it is possible to achieve immobilization of the blades within a braking length of 15 degrees.

The outer units, such as the second mower units 14, are adapted to the ground, for example, by a clearance in a coupling of the actuating element 106, said coupling being provided for actuating the swinging movement. This clearance is also used to achieve definition of the maximum admissible pivoting movement of the second mower units 14 during the mowing operation. The second mower unit 14 is adapted downwards to the ground by a pivotal point on the plane of the cutting blade and upwards by an upper pivotal point in the region of an upper side of the mower units 12, 14. The upper pivotal point also serves for the action of swinging in. Consequently, it is possible to achieve a compact design for optimum attachment to relatively low power front mower vehicles, for example between 35 and 40 HP.

The first mower unit 12 is provided with rotatable front roller feelers 86, whilst the second mower unit 14 has rear wheels 90 which are attached in a lateral manner and are only adjustable in a vertical manner. The rear wheels 90 are located approximately at the level of the vehicle wheels 92.

The vehicle connecting device 100 enables an attachment to the basic vehicle 44 which is broadened with respect to previous in-house solutions and is mounted by tie-rods. The cut product can be discharged by three cut product openings 114 which can be adapted, where required, especially to the design of the basic vehicle 44. The cut product openings 114 enable an individual discharge of the left-hand second mower unit 14, a triple discharge of the inside first mower unit 12 and an individual discharge of the right-hand second mower unit 14.

In addition, the mower deck 10 is able to be converted for a mulching operation in the manner described in DE 10 2005 050 215 A1 in order to make the first mower unit 12 into a mulching mower deck unit. A mulching system of the second mower units 14 can be effected, for example, by additionally attached deflection fingers (not shown) in the flow of material. Also, mechanical locking (not shown in any detail) is provided for the swung-in lateral second mower units 14 for transport.

In the case of a further embodiment, the lateral second mower units 14 have several rotary blades, for example two rotary blades in place of only one rotary blade. If a transport width of, for example, 1.8 m were to be retained, there would consequently be, for example, a cutting width of approximately 3.2 m; this version is suitable, for example, for higher-powered vehicles 44, e.g. for tractors from 50 HP. In the case of this embodiment also, the first mower unit 12 can be used in the manner shown without modification, the second mower units 14 simply being replaced by multiple rotary mower units (not shown).

In the case of the embodiment shown of the mower deck 10, second mower units 14 are provided on both sides. In the case of a further development which is not shown in detail, however, it is also possible for the mower mechanism to be designed in an asymmetrical manner, for example only one lateral second mower unit 14 being attached to the first mower unit 12. The first mower unit 12 is preferably provided with an operating width which overlaps the track width of the vehicle 44. Thus, even in the case of only one lateral second mower unit 14, it is possible to operate in a manner where tracks are overlapped (in a concrete development the mower deck could supply an operating width of 1.4 m on the inside, the outside width of the front wheels of the vehicle 44 being between 1.3 m and 1.35 m).

The second mower units 14 can be swung upwards for cleaning purposes and in this way can be sprayed down in a simple manner, for example using a water hose. The first mower unit can be provided with connecting pieces (not shown in any more detail) for a water hose in order, in this way, to clean the inside mower unit 12 in a simple manner. In the case of front mower vehicles with low lifting power, another additional framework (not shown in any more detail) could also be provided, the mower deck 10 being mounted on said additional framework in order to relieve the front coupling in this manner.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “outboard”, inboard”, “forward”, “rearward”, “above”, “downward”, “vertical”, “horizontal”, “below” and “transverse” as well as any other similar directional terms refer to those directions of a mower according to the present invention. Accordingly, these terms, as utilized to describe the present invention should be interpreted relative to a mower deck according to the present invention. The terms of degree such as “generally”, “substantially”, “about” and “approximately” as used herein mean a reasonable amount of deviation of the modified term such that the end result is not significantly changed. For example, two members that are angled less than ten degrees apart would be considered “generally perpendicular”, but two members that are angled more than fifteen degrees apart would not be considered “generally perpendicular”.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A mower deck comprising:
a first mower unit; and
a second mower unit coupled to the first mower unit by a double joint arrangement which enables the second mower unit to swing upward.

2. The mower deck according to claim 1, wherein the first mower deck includes a first mower housing having a vehicle coupling device configured to fasten to a vehicle; and
the second mower unit includes a second mower housing which is coupled to the first mower housing by the double joint arrangement which enables the second mower housing to swing downward.

3. The mower deck according to claim 1, further comprising
a drive device including a belt and chain drive configured to drive the second mower unit, the belt and chain drive extending from the first mower unit to the second mower unit.

4. The mower deck according to claim 1, wherein
the double joint arrangement includes
an upper hinge joint arrangement configured to pivot the second mower unit in relation to the first mower unit about an upper pivot axis and extending in a horizontal direction;
a lower hinge joint arrangement configured to pivot the second mower unit in relation to the first mower unit about a lower pivot axis and extending in the horizontal direction, the pivot axes extending in a substantially parallel manner;
a first stop that defines the pivoting movement about the upper pivot axis in a first pivoting direction; and
a second stop that defines the pivoting movement about the lower pivot axis in a second pivoting direction which is in an opposite direction to the first pivoting direction.

5. The mower deck according to claim 4, wherein
the double joint arrangement is pre-tightened by a pre-tightening device abutting against at least one of the first and second stops.

6. The mower deck according to claim 4, wherein
the double joint arrangement includes a plurality of double joints which, in the direction of the pivot axis, are arranged at a spacing with respect to each other and each include an upper and a lower hinge joint which form a the upper and lower hinge joint arrangements respectively, the hinge joints of each of the double joints are connected by a connecting rod.

7. The mower deck according to claim 1, wherein
the first mower unit includes at least one first cutting blade which is mounted to rotate about a first vertical axis; and
the second mower unit includes at least one second cutting blade which is mounted to rotate about a second vertical axis;
the first and second cutting blades being arranged to rotate substantially in a common cutting plane, such that a lower pivot axis of the double joint arrangement is arranged in or proximate to the cutting plane.

8. The mower deck according to claim 2, wherein
the first and second mower housings each includes an upper housing wall for closing off a top mower chamber, and an upper pivot axis of the double joint arrangement, which extends substantially parallel to a lower pivot axis of the double joint arrangement, extends at at least a level of the upper housing wall.

9. The mower deck according to claim 1, wherein
the double joint arrangement defines two pivot axes which are arranged offset with respect to each other both in a vertical direction of the mower deck and in a lateral direction which extends transversely with respect to the pivot axe, the pivot axes being further spaced from each other in the vertical direction of the mower deck than in the lateral direction.

10. The mower deck according to claim 1, wherein
the first mower unit is a middle mower deck element including a plurality of rotating first cutting blades, and the second mower unit is coupled to two opposite sides of the middle mower deck element to swing upward.

11. The mower deck according to claim 1, further comprising
an actuating element engaged above the double joint arrangement and configured to actuate a swinging movement between the first and second mower units, the actuating element including a first coupling which cooperates with the first mower unit, a second coupling which cooperates with the second mower unit and a displacement device configured to relatively displace the couplings, the actuating element or the displacement device being configured as a telescopic arm or telescopic cylinder.

12. The mower deck according to claim 1, wherein
the first mower unit includes a first drive which is connectable to a secondary drive of a vehicle to which the mower deck is configured to connect; and
the second mower unit includes a second drive having a controllable coupling configured to couple the second drive to the first drive.

13. The mower deck according to claim 1, further comprising
a belt and chain drive including a drive wheel arranged on the first mower unit and a driven wheel arranged on the second mower unit, at least one belt run of a traction device of the belt and chain drive is guided at a level of a pivot axis of the double joint arrangement.

14. The mower deck according to claim 13, wherein
the at least one belt run crosses an upper pivot axis of the double joint at an incline such that a direction of the belt run and a direction of the pivot axis coincide.

15. The mower deck according to claim 13, further comprising:
guide rollers configured to guide a tight belt run and a slack belt run of the belt and chain drive, the guide rollers being offset with respect to each other in the direction of the pivot axis at the level of the pivot axis and extending at an incline with respect to the pivot axis over a separation point between first and second mower units.

16. The mower deck according to claim 2, further comprising
a drive device including a belt and chain drive configured to drive the second mower unit, the belt and chain drive extending from the first mower unit to the second mower unit.

17. The mower deck according to claim 2, wherein
the double joint arrangement includes
an upper hinge joint arrangement configured to pivot the second mower unit in relation to the first mower unit about an upper pivot axis and extending in a horizontal direction;
a lower hinge joint arrangement configured to pivot the second mower unit in relation to the first mower unit about a lower pivot axis and extending in the horizontal direction, the pivot axes extending in a substantially parallel manner;
a first stop that defines the pivoting movement about the upper pivot axis in a first pivoting direction; and
a second stop that defines the pivoting movement about the lower pivot axis in a second pivoting direction which is in an opposite direction to the first pivoting direction.

18. The mower deck according to claim 2, wherein
the first mower unit includes at least one first cutting blade which is mounted to rotate about a first vertical axis; and
the second mower unit includes at least one second cutting blade which is mounted to rotate about a second vertical axis;
the first and second cutting blades being arranged to rotate substantially in a common cutting plane, such that a lower pivot axis of the double joint arrangement is arranged in or proximate to the cutting plane.

19. The mower deck according to claim 2, wherein
the double joint arrangement defines two pivot axes which are arranged offset with respect to each other both in a vertical direction of the mower deck and in a lateral direction which extends transversely with respect to the pivot axe, the pivot axes being further spaced from each other in the vertical direction of the mower deck than in the lateral direction.

20. The mower deck according to claim 2, wherein
the first mower unit is a middle mower deck element including a plurality of rotating first cutting blades, and the second mower unit is coupled to two opposite sides of the middle mower deck element to swing upward.
